(19) United States
(12) Patent Application Publication
(10) Pub. No.: US 2021/0234273 A1
(43) Pub. Date: Jul. 29, 2021

(54) PATCH ANTENNA USING BONDWIRES AS FREQUENCY TUNING ELEMENT

(71) Applicant: Innovation Sound Technology Co., Ltd, Shenzhen, Guangdong (CN)

(72) Inventors: Shun Ming Yuen, Shenzhen, Guangdong (CN); WaiYin Mung, Shenzhen, Guangdong (CN); Ka Ming Wu, Shenzhen, Guangdong (CN)

(21) Appl. No.: 16/313,872

(22) PCT Filed: Aug. 13, 2018
(86) PCT No.: PCT/CN2018/100146

§ 371 Date: Dec. 27, 2018

(30) Foreign Application Priority Data
Jul. 5, 2018 (CN) 201810731490.0

(51) Int. Cl. H01Q 5/314; H01Q 9/04

(52) U.S. Cl. CPC H01Q 5/314; H01Q 9/0407

(57) ABSTRACT

Disclosed is a patch antenna using bondwires as a frequency tuning element. The patch antenna includes a patch and bondwires frequency tuning circuit, wherein the bondwires frequency tuning circuit is disposed within radiation slots on one side of the patch, the bondwires frequency tuning circuit is a combination of multiple bondwires, and a sum of a length of the bondwires frequency tuning circuit and a length of the patch is equal to a length of the patch antenna. Compared with traditional patch antennae, the patch antenna according to embodiments of the disclosure, which is a patch antenna using a combination of bondwires as a frequency tuning element, uses bondwires as part of the antenna. Fine tuning of antenna frequencies is implemented by designing different combinations of bondwires such that the antenna per se have a better flexibility.

### TECHNICAL FIELD

The disclosure relates to the technical field of wireless communications, and in particular to a patch antenna using bondwires as a frequency tuning element.

### BACKGROUND

Current application of big data and the Internet of Things (IoT) or even the application of 5G mobile phones requires antennae for wireless transmission. Wireless transmission enables the IoT to extend into any area that is covered by a network, so as to break distance limitations. In this way, sensors, controllers, machines, personnel, objects and the like from broader fields are linked together in a new manner.

The Narrow Band IoT (NB-IoT) is an application of IoT based on global standards of mobile communication operators for open and authorized frequency bands. Its operation frequency band is based on 3GPP, thus an antenna frequency of a product is determined according to different requirements.

A patch antenna has a limited length and a limited width, thus there is a fringing field phenomenon (also referred to as fringing effect) in a field (radiation slot) near an edge of the metal patch of the antenna. FIG. 1 and FIG. 2 are respectively a schematic structural diagram and a schematic diagram showing an equivalent transmission line model of a traditional patch antenna. Since there are no charges stored at metal edges to maintain potential balance, a great number of charges are accumulated at the edges and form a capacity effect. Then, the antenna is equivalent to a segment of microstrip transmission line. Its radiations derive from radiations formed from edge fields (radiation slots) between the edge of the planar conductor and a grounded metal plane. The operation principle of the patch antenna lies in: when a wave transmits along a transmission line having a length that is an integral multiple of a half-wavelength of the wave, nodes will be generated at positions that are an integral multiple of a half-wavelength, then a standing wave is generated between nodes. Assuming that the transmission line is an ideal conductor, the standing wave will never disappear and its amplitude and phase remain constant. By means of this principle, the length (L) of the patch antenna is designed to be an integral multiple of the half-wavelength, and a wave transmits to the patch antenna along the transmission line so that resonance occurs between two open ends of the antenna. However, the patch antenna is not a closed transmission line, thus the wave will emit out from edges of the open ends. For an antenna equivalent to a transmission line having radiation slots, the wave emits out from the radiation slots.

### SUMMARY

Embodiments of the disclosure are intended to provide a patch antenna using bondwires as a frequency tuning element, so as to solve the technical problem described in the background section above.

To this end, a technical solution according to an embodiment of the disclosure is provided as follows.

There is provided a patch antenna using bondwires as a frequency tuning element. The patch antenna includes a patch and bondwires frequency tuning circuit, wherein the bondwires frequency tuning circuit is disposed within radiation slots on one side of the patch, the bondwires frequency tuning circuit is a combination of multiple bondwires, and a sum of a length of the bondwires frequency tuning circuit and a length of the patch is equal to a length of the patch antenna.

Compared with traditional patch antennae, the embodiments of the disclosure have the following beneficial effects: the patch antenna according to embodiments of the disclosure, which is a patch antenna using a combination of bondwires as a frequency tuning element, uses bondwires as part of the antenna. Fine tuning of antenna frequencies is implemented by designing different combinations of bondwires such that the antenna per se has a better flexibility.

### BRIEF DESCRIPTION OF THE DRAWINGS

FIG. 1 is a schematic structural diagram of an existing patch antenna.

FIG. 2 is a schematic diagram showing an equivalent transmission line model of an existing patch antenna.

FIG. 3 is a schematic structural diagram of a patch antenna according to an embodiment of the disclosure.

FIG. 4 is a schematic diagram showing an equivalent transmission line model of a patch antenna according to an embodiment of the disclosure.

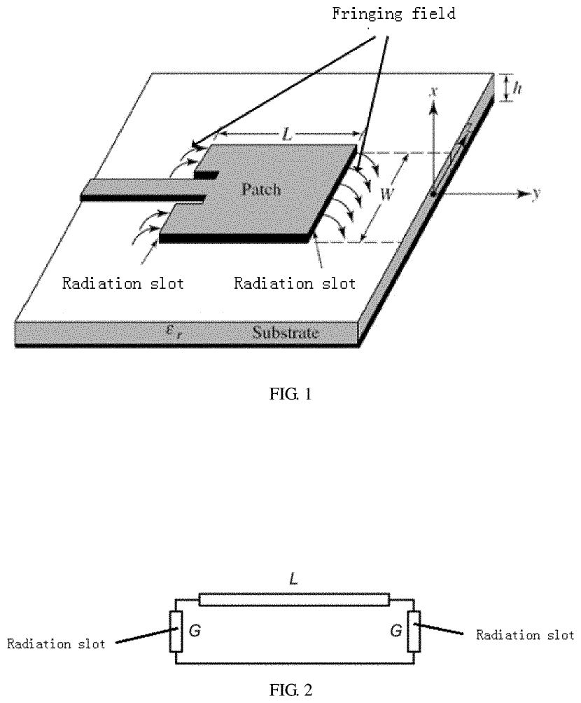

### DETAILED DESCRIPTION

Technical solutions according to embodiments of the disclosure will be described clearly and completely below with references to the accompanying drawings of the embodiments. It is apparent that the described embodiments are only part of the embodiments of the disclosure rather than all of the embodiments. All other embodiments obtained by those skilled in the art without inventive efforts based on the embodiments of the disclosure fall within the scope of protection of the disclosure.

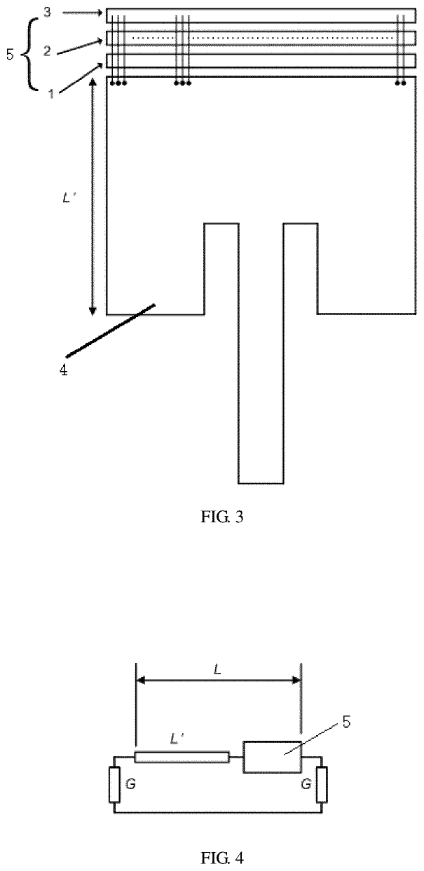

Referring to FIG. 3 to FIG. 4, an embodiment of the disclosure provides a patch antenna using bondwires as a frequency tuning element, including a patch 4 and bondwires frequency tuning circuit 5, herein the bondwires frequency tuning circuit 5 is disposed within radiation slots on one side of the patch 4. Assuming that the patch 4 has a length L′ and the bondwires frequency tuning circuit 5 has a length Lbondwires, then we have L′+Lbondwires=L (where L is the length of an existing patch antenna). The bondwires frequency tuning circuit 5 includes a combination of multiple bondwires. Taking a combination of 3 bondwires as an example, it may include a combination of different number of bondwires having a same length, such as a combination of line 1, line 2 and line 3 or a combination of line 1 and line 2 that have a same length. A combination of bondwires having different lengths (such as a combination of line 1 and line 2 that have different lengths) and having different heights will result in different Lbondwires, thereby different antenna frequencies may be obtained. According to this principle, during designing and manufacturing of the patch antenna, the length L′ can be determined firstly to obtain a patch; then different combinations of bondwires can be designed according to requirement of specific products. Therefore, it is possible to design antenna products having different frequencies, and this is particularly suitable for designing a relatively precise product during fine tuning of the frequencies of the product.

Those skilled in the art will appreciate that the disclosure is not limited to the details as described in the above exemplary embodiments, and the technical solutions of the disclosure can be implemented in other specific manner without departing from the spirits or basic features of the disclosure. From every point of view, the embodiments as described are exemplary only and are not limiting. The scope of the disclosure is indicated by the appended claims rather than by the foregoing description, and all changes which come within the meaning and range of equivalency of the claims are therefore intended to be embraced therein. Any reference signs in the claims shall not be construed as limiting the claim concerned.

In addition, it is to be noted that description is made based on specific embodiments, but it does not mean that each embodiment only includes an independent technical solution, and such description is only made for the sake of clarity. Those skilled in the art should appreciate the description in its entirety. Technical solutions according to various embodiments of the disclosure can be combined appropriately so as to obtain other embodiments that can be conceived by those skilled in the art.

1. A patch antenna using bondwires as a frequency tuning element, comprising a patch (4) and bondwires frequency tuning circuit (5), wherein the bondwires frequency tuning circuit (5) is disposed within radiation slots on one side of the patch (4), the bondwires frequency tuning circuit (5) is a combination of multiple bondwires, and a sum of a length of the bondwires frequency tuning circuit (5) and a length of the patch (4) is equal to a length of the patch antenna.
